(19) United States
(12) Patent Application Publication
(10) Pub. No.: US 2008/0227664 A1
(43) Pub. Date: Sep. 18, 2008

(54) CELL ARRAY STRUCTURAL BODY AND CELL ARRAY

(75) Inventors: Tsutomu Honma, Fuchu-shi (JP); Atsushi Takahashi, Kawasaki-shi (JP); Takahisa Ibii, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/038,304

(22) Filed: Feb. 27, 2008

(30) Foreign Application Priority Data
Mar. 16, 2007 (JP) 2007-069083

(51) Int. Cl. C40B 60/12

(52) U.S. Cl. 506/39

(57) ABSTRACT

The present invention provides a cell array structural body containing a substrate, a plurality of micropores piercing the substrate from one surface to another surface, through which a sample cell can pass, and a capture/release unit for the sample cell on a wall surface of each micropore, as well as a cell array with such structural body detachably immobilizing sample cells in its micropores. In using the cell array structural body and the cell array for drug evaluations or the like, handling of a culture medium or a drug solution, or washing procedure is easy, and harvest of a desired cell from the cell array is easy and trustworthy.

### BACKGROUND OF THE INVENTION

1. Field of the Invention

The present invention relates to a cell array structural body and a cell array.

2. Description of the Related Art

For evaluation of drugs using cells a container such as a dish or a flask, or a 96-well microtiter plate has been conventionally used. A cell array arraying cells on a glass or other substrate similar to a DNA chip for gene analysis has been under development to meet recent requirements for high-throughput, automated, low-cost drug evaluation. It is expected that the cell array will be usable for evaluation of efficacy and safety of drugs, medical diagnosis using a cell, screening of a cell having a particular function, or gene expression analysis using a cell.

Various types of cell arrays have been proposed. For example, Japanese Patent Application Laid-Open No. 2003-033177 discloses a substrate for a high density cell array, on which a plurality of coated regions with a cell-adhesive polymer are placed discretely within a region coated with a cell-nonadhesive hydrophilic polymer, which is then surrounded by a continuous region coated with a cell-nonadhesive strong hydrophobic material. Further, Japanese Patent Application Laid-Open No. 2004-173681 discloses a micro-well array chip having a plurality of micro-wells, each of which accommodates a sample lymphoid cell to detect a single antigen-specific lymphoid cell.

A cell array is a promising device for high-throughput, automated, low-cost drug evaluation using cells, since many samples can be analyzed simultaneously on a single chip. However, with a cell chip developed thus far, which retains cells at a surface of a plain substrate or in micro-wells, treatments required for drug evaluation using cells, such as exchange of a culture medium or a drug solution, or washing of cells, are cumbersome to be done. Further with a conventional cell array to isolate a specific cell out of many cells, it is necessary to pick up the target cell to be identified under a microscope, using a special apparatus such as a micromanipulator. The handling is quite complicated and needs high skills.

### SUMMARY OF THE INVENTION

An object of the present invention is to provide a cell array and a structural body therefor, which have a construction allowing easy handling of a culture medium or a drug solution, easy washing procedure, as well as easy and secured isolation of a target cell from the cell array, in the use for a drug evaluation.

The cell array structural body of the present invention has a substrate, a plurality of micropores piercing the substrate from one surface to another surface, through which a sample cell can pass, and a capture/release unit for the sample cell on a wall surface of each micropore.

In the cell array of the present invention, a cell is retained in each micropore of the cell array structural body having the aforementioned construction.

Further features of the present invention will become apparent from the following description of exemplary embodiments with reference to the attached drawings.

### BRIEF DESCRIPTION OF THE DRAWINGS

FIG. 1 is a perspective view of an exemplary cell array structural body of the present invention.

FIG. 2 is a cross-sectional view of an exemplary cell array structural body of the present invention.

FIG. 3 is a cross-sectional view of an exemplary cell array structural body of the present invention.

FIG. 4 is a schematic drawing illustrating an exemplary arrangement of electrodes generating a non-uniform electric field of the present invention.

FIG. 5 is a schematic perspective view of the cell array structural body of Example 1.

FIG. 6 is a cross-sectional view of the cell array structural body of Example 1.

FIG. 7 is a plan view of a first structural element to be used for producing the cell array structural body of Example 1.

FIG. 8 is a plan view of a second structural element to be used for producing the cell array structural body of Example 1.

FIG. 9 is a cross-sectional view illustrating a procedure for producing the cell array structural body of Example 1.

FIG. 10 is a schematic perspective view of the cell array structural body of Example 5.

FIG. 11 is a cross-sectional view of the cell array structural body of Example 5.

FIG. 12 is a plan view of a first structural element to be used for producing the cell array structural body of Example 5.

FIG. 13 is a plan view of a second structural element to be used for producing the cell array structural body of Example 5.

FIG. 14 is a cross-sectional view illustrating a procedure for producing the cell array structural body of Example 5.

FIG. 15 is a schematic perspective view of the cell array structural body of Example 1.

FIG. 16 is a perspective view illustrating a method for producing the cell array of Example 6.

FIG. 17 is a cross-sectional view illustrating a method for producing the cell array of Example 6.

FIG. 18 is a cross-sectional view illustrating a method for producing the cell array of Example 6.

FIG. 19 is a cross-sectional view of the cell array of Example 6.

FIG. 20 is a perspective view illustrating a method for using the cell array structural body of Example 15.

FIG. 21 is a cross-sectional view illustrating a method for using the cell array structural body of Example 15.

### DESCRIPTION OF THE EMBODIMENTS

The cell array structural body of the present invention has micropores piercing a substrate from one surface to another surface. The micropores are so structured that sample cells can pass therethrough. In other words the cross-section of a micropore is defined broader than a sample cell. Namely, in case the cross-section of a micropore is round, its diameter is made larger than the size of a sample cell, and in case the cross-section of a micropore is square, the lengths of the sides are made larger than the size of a sample cell. The micropores bored in the substrate have their respective capture/release units on their wall surfaces. By the retention of sample cells with the capture/release units, various tests and treatments can be performed with the sample cells being retained in the micropores. A gap is left between a wall surface of a micropore and a sample cell at its retained position, thereby allowing a fluid to flow from an opening of the micropore to the other opening, which enables easy changing of a culture medium or a drug solution, or washing of the cell. Further the capture and release of a cell can be regulated with respect to an individual micropore. By such regulation, selection and recovery of a specific cell can be easily carried out. The micropores can be arranged on the substrate forming an array or a grid.

“A sample cell” refers hereunder to a cell to be captured on or released from a cell array structural body for various purposes, and includes such an animal cell, a plant cell and a microorganism cell, as exemplified below. “Capture/release of a sample cell” means hereunder that a sample cell can be captured and immobilized in the substrate at a desired timing, and that such captured and immobilized cell can be released and mobilized at a desired timing. Therefore, “a capture/release unit for a sample cell” means hereunder a unit which can capture and immobilize a sample cell on the substrate at a desired timing, and can release and mobilize at a desired timing the sample cell captured and immobilized at least at a part of the substrate.

A cell array structural body and a cell array of the present invention will be described below by means of exemplary embodiments and drawings.

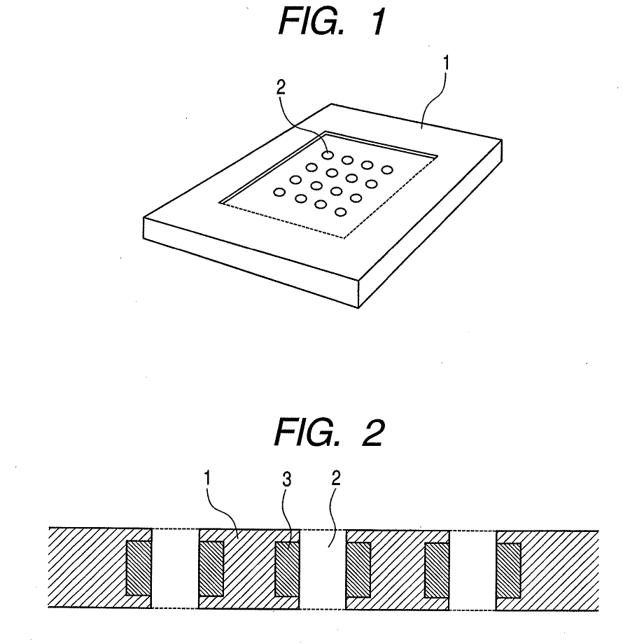

An example of a cell array structural body is illustrated in FIG. 1 and FIG. 2. As illustrated in FIG. 1 and FIG. 2, the example of a cell array structural body including a substrate 1 having a plurality of micropores 2 piercing from a surface to another surface. And as illustrated in FIG. 2, a wall surface of a micropore 2 is equipped with a capture/release unit for a sample cell 3.

For a substrate 1 of the cell array structural body of the present invention, various substrates such as silicon, glass, plastics, pierced with a plurality of micropores 2 in an array can be used. There are no restrictions on the size of the substrate 1, however, a thickness of 300 to 1000 μm is commonly used. There are no restrictions on the shape of the cross-section of a micropore 2, and square, oblong, round, oval, triangular section may be used. Any size of a micropore 2 may be employed, so long as a sample cell can pass through. It is desirable that a liquid can flow through a micropore, in which a sample cell is retained. If the cross-section having sides and angles the lengths of the sides, and if it is round the length of the diameter (in case of an oval section, the minor axis diameter) should be preferably less than 1000 μm, and its lower limit is defined only by passability of a sample cell. A lower limit length should be large enough for a sample cell to pass through, and more specifically the length of the diameter (in case of a round section) or the side (in case of a square section) should be preferably at least 1.5 times as large as the size of a sample cell leaving a sufficient space. Lacking a free space in a micropore 2, such a trouble may happen that a sample cell cannot pass through a micropore 2 due to eventual change of a cell form or a relative configuration of a plurality of cells. Further, a micropore 2 may be plugged by a cell, which could deteriorate some advantages of the present invention of easiness in liquid exchange and recovery of a cell. Although the absolute size of a micropore 2 should be optimized in accordance with the size of a sample cell, the order of the sizes is unchanged. For example, assuming that the diameter of a sample cell is 20 μm, the length of the side (in case of a square section) or the diameter (in case of a round section) should be substantially larger than 20 μm, e.g. about 500 μm. For a polygon other than a square, certain adjustment is possible. For instance in case of a 16-sided polygon, the length of a side may be shorter than 20 μm. Generally, the size of a sample cell falls within the range of several μm to several tens μm, and therefore the length of the side (in case of a square section) or the diameter (in case of a round section) of a micropore 2 should be preferably optimized in the range between 10 and 1000 μm. For further generalization, a diameter of an inscribed circle in the cross-section of a micropore should be preferably between 10 and 1000 μm, further preferably between 100 and 1000 μm.

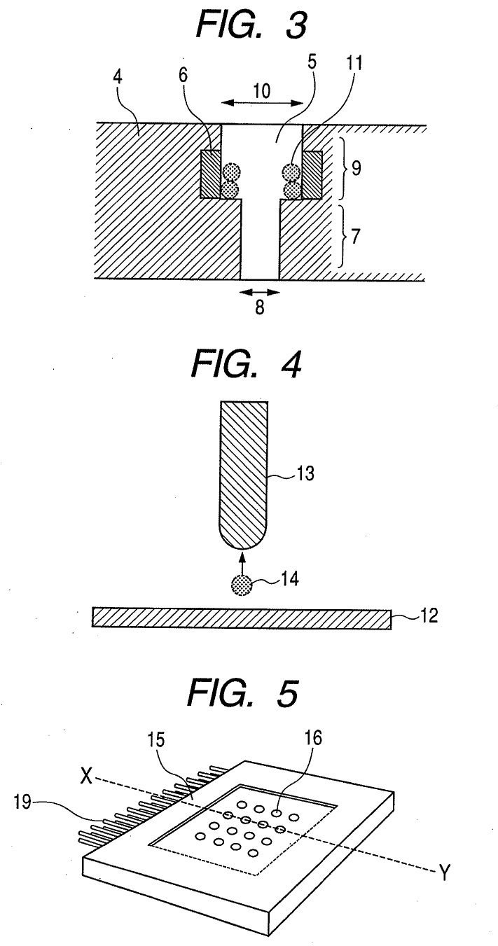

A geometric structure of a micropore including the size and shape of the cross-section may be uniform from an opening at a surface of a substrate to the other opening at the opposite surface. Alternatively as illustrated in FIG. 3, the length 8 of the sides or the diameter of the cross-section of a first region 7 below a capture/release unit 6 for a sample cell may be smaller than the length 10 of the sides or the diameter of the cross-section of a second region 9 equipped with the capture/release unit 6 for a sample cell. By such a structure a shelf is formed at the border between the first region 7 and the second region 9, which offers a convenient structure to accommodate a plurality of sample cells 11. Further with the shelf a sample cell can be captured more effectively and retained at the location of the capture/release unit. With a cell array structural body having the structure illustrated in FIG. 3, cells should better be supplied from the upper side of the drawing into a micropore.

More generally, the similar structural effect can be obtained as the cell array structural body illustrated in FIG. 3, by making the cross-section of a micropore in the region between the region equipped with a capture/release unit for a sample cell and an opening at a surface same as or larger than the cross-section of the micropore in the region equipped with a capture/release unit for a sample cell, and the cross-section of the micropore at least at a part of the region between the region equipped with a capture/release unit for a sample cell and the other opening at the opposite surface smaller than the cross-section of the micropore in the region equipped with a capture/release unit for a sample cell.

Although there is no restriction on the number of micropores to be incorporated in a cell array structural body, by consideration of positioning of such parts as electrodes, the range can be 1 to 1,000 per 1 cm².

Further, there is no restriction on the method for piercing micropores into a substrate. For example, micro-boring by sandblasting with a blast-mask on the substrate, drilling with a diamond-drill, or perforation by etching using a resist may be applied.

The surface of a substrate to be used for the present invention may be modified, if necessary. For example, if a slide glass or quartz plate is used as a substrate, its surface may be pretreated with a surface modifier such as an acid, plasma, ozone, an organic solvent, an aqueous solvent and a surfactant. Further a treatment with a silane coupler to introduce a functional group on the surface, or a treatment to modify the surface free energy may be carried out.

As described above, a micropore in a cell array structural body is equipped at its wall surface with a capture/release unit for a sample cell. With an example of FIG. 2, a capture/release unit for a sample cell 3 covers almost all range of the micropore. Although there are no restrictions on a type of a capture/release unit for a sample cell, a unit which can regulate capture and release of a sample cell for the respective micropores independently is preferable. The capture/release unit for a sample cell may be placed over the whole range of a micropore, or only at a desired part of a micropore. If placed only at a part, the aforementioned structure of FIG. 3 may be applicable.

For example, as a component for the capture/release unit for a sample cell, a stimuli-responsive polymer is used favorably. The capture/release unit can be formed by exposing a stimuli-responsive polymer on a sidewall of a micropore, (so that it can contact a sample cell). More precisely a region with an exposed stimuli-responsive polymer is formed on a sidewall of a micropore. The cell adhesiveness of the surface of the stimuli-responsive polymer is changed by stimulating the region, through which capture and release of a sample cell can be regulated.

As a stimuli-responsive polymer a photo-responsive polymer and a temperature-responsive polymer are known, and a temperature-responsive polymer is favorably used due to easiness in regulation and mild influence on a cell. Both homopolymer and copolymer can be used as a temperature-responsive polymer of the present invention. Examples of basic units for usable temperature-responsive polymers are: (meth)acrylamides such as acrylamide, methacrylamide, N-alkyl-substituted-(meth)acrylamide derivatives such as N-ethylacrylamide (transition temperature 72° C.), N-n-propylacrylamide (do. 21° C.), N-n-propylmethacrylamide (do. 27° C.), N-isopropylacrylamide (do. 32° C.), N-isopropylmethacrylamide (do. 43° C.), N-cyclopropylacrylamide (do. 45° C.), N-cyclopropylmethacrylamide (do. 60° C.), N-ethoxyethylacrylamide (do. about 35° C.), N-ethoxyethylmethacrylamide (do. about 45° C.), N-tetrahydrofurfurylacrylamide (do. about 28° C.), N-tetrahydrofurfurylmethacrylamide (do. about 35° C.); N,N-dialkyl-substituted-(meth)acrylamide derivatives such as N,N-dimethyl(meth)acrylamide, N,N-ethylmethylacrylamide (transition temperature 56° C.), N,N-diethylacrylamide (do. 32° C.); further (meth)acrylamide derivatives having a cyclic group such as 1-(1-oxo-2-propenyl)-pyrrolidine (do. 56° C.), 1-(1-oxo-2-propenyl)-piperidine (do. about 6° C.), 4-(1-oxo-2-propenyl)-morpholine, 1-(1-oxo-2-methyl-2-propenyl)-pyrrolidine, 1-(1-oxo-2-methyl-2-propenyl)-piperidine, 4-(1-oxo-2-methyl-2-propenyl)-morpholine; vinyl ether derivatives such as methyl vinyl ether (transition temperature 35° C.). In order to modify a transition temperature in accordance with a type of a cell, or to enhance the affinity between a coating material and a substrate, or to adjust the hydrophilic/hydrophobic balance of a cell-adhesive surface, copolymers with other monomers than those listed above, grafted polymers, blends of polymers and copolymers may be used. The polymers may be cross-linked so long as their inherent properties are not damaged. By cooling below a transition temperature an abovementioned temperature-responsive polymer turns to highly hydrophilic forming a cell-nonadhesive surface, and beyond such temperature it turns to slightly hydrophobic forming a cell-adhesive surface.

As a method for setting a stimuli-responsive polymer to the wall surface of a micropore, or a method for covering the sidewall of a micropore with a stimuli-responsive polymer, application of a stimuli-responsive polymer to the wall surface, bonding of a stimuli-responsive polymer with the wall surface by a chemical reaction, or a utilization of a physical interaction are used independently or jointly. In case of a chemical reaction, irradiation of an electron beam, irradiation of γ-rays, irradiation of UV rays, a plasma treatment and a corona treatment are applicable. Considering applicability of such treatments, it is preferable that the substrate should be transparent to irradiated rays. If either or both of the wall surface and the stimuli-responsive polymer have appropriate reactive functional groups, any of usual organic-chemical reactions, such as a radical reaction, an anionic reaction and a cationic reaction may be utilized. If a substrate with the abovementioned reactive functional group is laminated between substrates without such reactive functional group, only the middle part of a micropore can be efficiently coated. In such case, the substrates pre-fabricated with micropores may be laminated together, or the laminated substrate may be pierced with micropores. In case of a physical interaction method, physical adsorption such as blending or coating with a coating material alone, or together with a matrix as a medium having good compatibility with the substrate (for example a graft polymer or a block-copolymer, between a coating material and a monomer constituting the substrate, or a monomer having good compatibility with the substrate), may be applicable.

The lamination method with plural substrates can be favorably used to form a shelf structure illustrated in FIG. 3.

With a stimuli-responsive polymer, it is preferable to install a unit for stimulating the stimuli-responsive polymer as an additional constituent of a capture/release unit for a sample cell. If a photo-responsive polymer is used as a stimuli-responsive polymer, a device for irradiating the region of a micropore covered with the photo-responsive polymer is added as a stimulating unit. If a temperature-responsive polymer is used as a stimuli-responsive polymer, an electricity-heat converter converting an electrical signal to heat, such as a micro-heater, is favorably used as a stimulating unit. As the electricity-heat converter, a converter using a resistance heater made of a metal, an alloy or a metal compound, such as Ta₂N, RuO₂, Ta and Ta—Al alloys can be used. The resistance heater can be produced by known methods, such as DC sputtering, RF sputtering, ion-beam sputtering, vacuum deposition or CVD. It is preferable that the electricity-heat converter should be located in the vicinity of the region of the temperature-responsive polymer. Herein the term “vicinity” means a site from where heat can be transported to a desired site in a micropore (the region with the temperature-responsive polymer). So long as located at such site, the electricity-heat converter may be inside a micropore, or outside a micropore, and on the substrate surface or buried in the substrate. For example, a printed circuit board with built-in heaters is laminated with a substrate to build electricity-heat converters which can heat desired sites to a defined temperature, and similarly the board with Peltier elements is laminated to build electricity-heat converters which can chill desired sites to a defined temperature. In order to regulate the temperature-responsive polymer in the respective micropores, it is preferable that an electricity-heat converter should be allocated to each micropore (namely one each for a micropore, or one each for a group of plural micropores).

Further, dielectrophoresis phenomenon may be also utilized for another type of a capture/release unit for a sample cell.

Dielectrophoresis is a movement of a polarizable substance or object in a spatially non-uniform electric field generated by an impressed alternating voltage of radio frequency zone. Differently from the well-known electrophoresis, dielectrophoresis is not subject to a Coulomb force, and is applicable to capture or transportation of a substance or object without an electric charge. The dielectrophoretic force is generated by interaction between the non-uniformity of an electric field and the relocated electric charges in a target particle for separation induced by the electric field.

Since the dielectrophoretic force is induced by a non-uniform electric field generated by an impressed alternating voltage of radio frequency zone, and due to the limited relaxation time of an electric double layer, the influence of the electric double layer on a small particle can be neglected. Further characterized is that the capture/release of an object by dielectrophoresis is applicable to a non-electric-charged substance, and an influence on the object is limited. Supposing probe electrodes and a particle in a non-uniform electric field, two types of dielectrophoretic force are possible depending on the nature of the particle. If the particle is easier to be polarized than its surrounding medium such as a solvent, a dielectrophoretic force pushing the particle to a stronger electric field region (positive dielectrophoretic force) is observed. Reversely, if the particle is less polarizable than the surrounding medium, a dielectrophoretic force pushing the particle to a weaker electric field region (negative dielectrophoretic force) is observed. Either of the dielectrophoretic forces can be selected in accordance with the composition of an array.

Applying the above principle to a cell, and selecting the conditions that make the dielectric constant of the cell to be retained in electrodes larger than the dielectric constant of the medium (i.e. a positive dielectrophoretic force works), the cell can be captured and immobilized by an electrode. Further, by temporary extinction of the dielectrophoretic force by stopping impressing voltage on the electrodes, or by producing a negative dielectrophoretic force, the immobilized cell can be easily released and mobilized. Preparing electrodes forming a plurality of non-uniform electric fields, which electrodes can be regulated independently, each region in a cell array can be independently regulated for capture/release of a sample cell.

There are no restrictions on a form or a material of the “electrodes forming a non-uniform electric field”, so long as they form a non-uniform electric field. The “electrodes forming a non-uniform electric field” generally has a pair of electrodes facing each other. Examples of the electrode pair are: a pair of a plate electrode and a rod-like electrode facing each other as illustrated in FIG. 4, and a pair of interdigital electrodes. For more details of the electrodes of FIG. 4, a first electrode 12 is a linear or planar electrode, and a second electrode 13 is a rod-like electrode (more accurately a point-like tip of a rod). In this case a non-uniform electric field fanning out from the second electrode 13 to the first electrode 12 is impressed on a cell 14. As the materials for the electrodes, aluminum, gold, platinum are preferable, but not limited thereto. As the materials for a substrate of the electrodes, glass is preferable, but any insulators can be used without limitation. The electrodes can be formed on the substrate by known methods, for example by forming a layer by sputtering, vapor deposition or plating, followed by etching by photolithography.

A preferable electric signal to be impressed on the “electrodes forming a non-uniform electric field” to generate a dielectrophoretic force of the present invention is a sinusoidal alternating current in radio frequency zone. The radio frequency zone refers to a frequency zone of 100 kHz to 100 MHz. In the present invention, considering Joule heat in a small space and its influence on the device, the range of 100 kHz to 10 MHz is preferable. Further, the impressed voltage is preferably selected from the range of 1 to 10 V. By impressing such alternating voltage on the “electrodes forming a non-uniform electric field”, a non-uniform electric field can be generated.

As a sample cell to be combined with a cell array structural body to make a cell array, a microorganism cell, an animal cell and a plant cell can be exemplified. More particularly, prokaryotic cells, such as E. coli, Streptomyces, Bacillus subtilis, Streptococcus and Staphylococcus; eukaryotic cells, such as yeast, Aspergillus; insect cells, such as Drosophila S2, Spodoptera Sf9; and animal and plant cells, such as L cell, CHO cell, COS cell, HeLa cell, HL60 cell, HepG2 cell, C127 cell, BALB/c3T3 cell (including a mutant deficient in dihydrofolate reductase or thymidine kinase), BHK21 cell, HEK293 cell, Bowes melanoma cell, oocyte, T cell can be named.

Further, to facilitate the detection of a magnitude of an influence of an analyte on a cell in situ, a transformed cell can be used as a sample cell. For example a transformed cell having a reporter gene downstream of a promoter of a candidate gene to be expressed by a contact with an analyte is prepared by a generally known method. As a reporter gene, DNA encoding a fluorescent protein such as a green fluorescent protein (GFP), or a gene for an enzyme such as luciferase (firefly or bacterial luciferase) or galactosidase can be exemplified, and the DNAs encoding fluorescent proteins such as GFP are preferable among them due to easiness in detection. There are some GFP derivatives showing different fluorescence wavelengths, such as EGFP (enhanced GFP), EYFP (enhanced yellow fluorescent protein), ECFP (enhanced cyan fluorescent protein-cyan color), DsRed (red color), and multiple labeling is possible. The advantage of GFP is that a living cell can be examined directly which enables easy continuous observation.

An example of producing a cell array using a cell array structural body of the present invention is described below. On the upper surface of a cell array structural body a liquid containing sample cells is filled, which is sucked gently from the bottom side of the cell array structural body to introduce the suspended sample cells into micropores, and then the capture/release units for sample cells are operated to immobilize the sample cells in the micropores.

A cell array of the present invention is used for carrying out various tests or treatments on a sample cell retained in a micropore. As a liquid can flow from an opening through to the other opening of the micropore, change of a culture medium or a drug solution and washing of a cell can be done easily. Further as the capture/release of a cell can be regulated for each micropore, a specific cell can be easily selected and harvested.

By filling the micropore with a culture medium, sample cells can be cultured on the cell array. Through cell culture effete matters may accumulate, which may often have a negative impact on existence or function of the cell. In usual cell culture with a flask or a dish, an old culture medium is exchanged with a new culture medium by pipetting, however, such medium exchange procedure has been quite difficult with a conventional cell array. On the contrary, with the cell array of the present invention the exchange of a culture medium is quite easily carried out. Namely, a new culture medium is placed on the top surface of a cell array, which is sucked gently from the bottom side to replace the culture medium in micropores. If necessary such procedure can be done continuously replacing the medium with a new medium to carry out a “continuous culture”.

To expose a cell to a drug using a cell array of the present invention, a solution containing an analyte drug is filled on the top surface of the cell array, which is sucked gently from the bottom side to fill micropores with the drug solution to realize the contact between the cells and the analyte drug. In the event cells should be exposed respectively to different kinds of drugs or concentrations of a drug, micro-channels may be prepared to the respective micropores, or the drugs may be delivered respectively by using an ink-jet printer or the like.

Washing of a sample cell is a common technique in a drug evaluation using a cell for removing contaminants or unnecessary drugs. The technique is especially important for regulating accurately the exposure time to a drug, or to remove a non-binding antibody by a treatment of cells with a labeled antibody. In case of a cell culture with a flask or a dish, slurrying and recovering of cells by means of centrifuging or pipetting are repeated to wash the cells, which washing technique is quite cumbersome with a conventional cell array. However washing of cells with the cell array of the present invention is quite easy as described below. A washing liquid such as a buffer solution is placed on the top surface of a cell array, which is sucked gently from the bottom side to replace a liquid in micropores with the washing liquid.

Since, if required, a cell immobilized in a micropore of the cell array of the present invention can be easily released and mobilized, after an analysis on the cell array, sample cells can be easily harvested for use in another test. If, according to an analysis on a cell array, a cell retained in a specific micropore is required to be harvested, with a conventional cell array a very complicated operation using a micro-manipulator for recovering a cell selected under a microscope is necessary. On the contrary, with the cell array of the present invention, a specific cell can be quite easily recovered, since only the desired cell of the micropore is to be released and mobilized. In the event that sample cells should be harvested, it is desirable to use a cell array, which accommodates 1 to several cells per each micropore (for example by regulating the concentration of sample cells in a suspension). If a temperature-responsive polymer is used for a capture/release unit for a sample cell, the temperature of the desired micropore is changed to modify the cell adhesiveness and only the cell in the specific micropore can be recovered. If a dielectrophoresis element is used for a capture/release unit for a sample cell, the impressed voltage of the desired micropore is changed to release the captured cell and only the cell in the specific micropore can be recovered. This function is very valuable also for separating living cells from dead cells, for selecting a specific kind of cells out of a population of cells, or for selecting cells having a specific function. This function of a cell array is very valuable for a drug development, a clinical test, a drug toxicity test, and screening of a cell or a microorganism producing industrially valuable substances. The released cells can be harvested by placing a liquid such as a culture medium on the top surface of the cell array, which is sucked gently from the bottom side to recover the cells under the cell array.

Examples of an analyte are: solutions of chemicals, such as various mutagenic substances, endocrine disrupting chemicals, drug candidates, heavy metal ions, neurotransmitters, cytokines, interleukins, and body fluids, such as serum. A magnitude of an influence of an analyte on a cell can be measured by detecting signals derived from the cell in each micropore, for example, by photodiodes capable of spatial resolution, such as a CCD camera or a photodiode array, scanners or photographic dry plates.

Some Examples of the aforementioned cell array structural body will be described below with reference to the drawings, provided that the scope of the technology of the present invention is not limited thereto.

### EXAMPLES

### Example 1

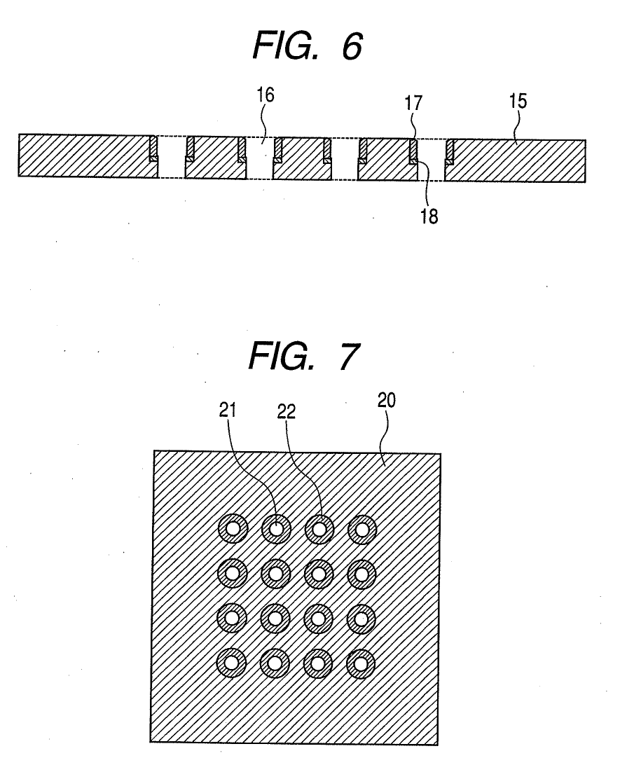

FIG. 5 is a schematic perspective view of a cell array structural body, and FIG. 6 is a cross-sectional view taken along the line X-Y in FIG. 5. The cell array structural body has a glass substrate 15 with a thickness of 2.0 mm, in which micropores 16 pierce from the top surface to a bottom surface. Further, temperature-responsive polymer layers 17 and electricity-heat converters having a resistance heater layer 18 are equipped on the wall surfaces in the micropores. Further, electrodes 19 are connected to the electricity-heat converters. They are the main constituents of the structural body. The temperature-responsive polymer layer 17 of this Example is formed by immobilizing a layer of poly-(N-isopropylacrylamide) by covalent bonds on the wall surface of a micropore. The electricity-heat converter has a resistance heater layer 18 made of Ta₂N and electrodes 19 connected with the resistance heater layer 18. The electrodes 19 are to send a current to the resistance heater layer 18 to generate heat, and the electrodes 19 are connected individually to a resistance heater layer 18, so that a selective current can flow to each resistance heater layer 18 is possible.

Next, a procedure for producing a cell array structural body of this Example will be described with reference to the drawings. FIGS. 7 to 9 illustrate the procedure for producing a cell array structural body of this Example.

FIG. 7 is a plan view from the upper side of the substrate of a first structural element to be used for producing the cell array structural body of this Example. The element has the first glass substrate 20 with a thickness of 1.0 mm pierced by micropores 21 with the diameter of 600 μm, and temperature-responsive polymer layers 22 on the inner wall surfaces of the micropores 21. The micropores 21 are arranged to form a grid of 4×4 with a gap of 3.0 mm.

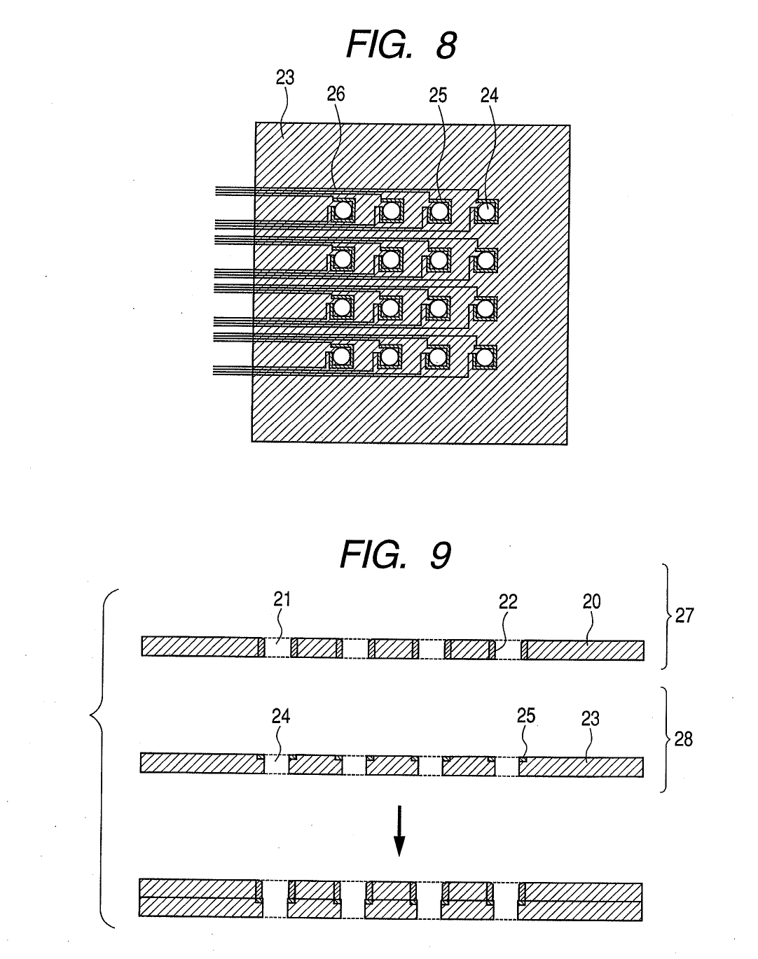

FIG. 8 is a plan view from the upper side of the substrate of a second structural element to be used for producing the cell array structural body of this Example. The element has the second glass substrate 23 with a thickness of 1.0 mm pierced by micropores 24 with the diameter of 500 μm, and electricity-heat converters having a resistance heater layer 25 around a micropore 24, and electrodes 26. The micropores 24 are arranged to form a grid of 4×4 at the locations corresponding to the micropores 21 of the first structural element.

FIG. 9 is a cross-sectional view of the first structural element and the second structural element illustrating a procedure for producing the cell array structural body of this Example using the elements. The first structural element is prepared by dipping the first glass substrate 20 with micropores 21, formed by sandblasting, into a 30% solution of N-isopropylacrylamide, then wiping off the adsorbed solution of N-isopropylacrylamide from the surfaces other than in micropores 21, and then irradiating it with a electron beam (dose 0.25 MGy) to form immobilized poly-(N-isopropylacrylamide). The second structural element is produced by forming electricity-heat converters with resistance heater layers 25 and electrodes 26 on the second glass substrate 23, then placing a blast mask thereon, and piercing micropores 24 by sandblasting. After arranging the micropores collinearly, the first structural element 27 and the second structural element 28 are laminated with a bonding agent to build a cell array structural body of this Example.

### Example 2

A cell array structural body of this Example is produced as in Example 1, except that poly-(N-n-propylmethacrylamide) is used instead of poly-(N-isopropylacrylamide).

### Example 3

A cell array structural body of this Example is produced as in Example 1, except that poly-(N,N-diethylacrylamide) is used instead of poly-(N-isopropylacrylamide).

### Example 4

A cell array structural body of this Example is produced as in Example 1, except that the following first structural element and second structural element are used.

### The First Structural Element:

diameter of micropores: 300 μm
capture/release unit: a temperature-responsive polymer layer attached onto an inner wall surface of micropores arrangement of micropores: a grid of 6×6 with gaps of 3.0 mm

### The Second Structural Element:

diameter of micropores: 200 μm
heating unit: electricity-heat converters having a resistance heater layer around a micropore, and electrodes
arrangement of micropores: a grid of 6×6 at the locations corresponding to the micropores of the first structural element.

### Example 5

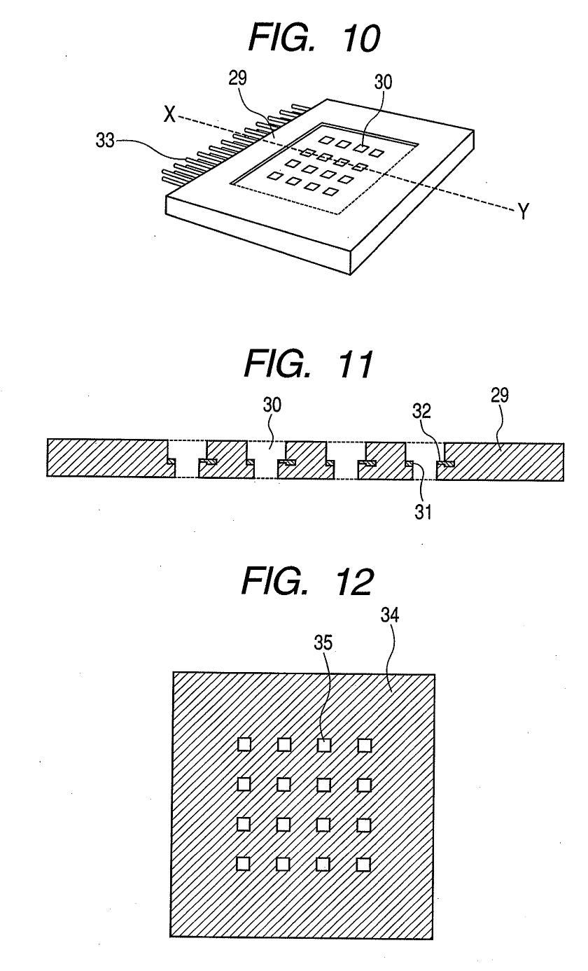

FIG. 10 is a schematic perspective view of the cell array structural body of this Example, and FIG. 11 is a cross-sectional view taken along the line X-Y in FIG. 10. The cell array structural body has a glass substrate 29 with a thickness of 2.0 mm, which has micropores 30 piercing from the top surface to a bottom surface thereof, and planar gold electrodes 31 parallel to a wall surface of the micropores 30, if viewed from the upper side of the substrate. The cell array structural body of this Example has further a rod-like gold electrode 32 arranged perpendicular to a wall surface of the micropore 30, if viewed from the upper side of the substrate, at a inner wall surface of the micropore 30, so that a planar gold electrode 31 and a rod-like gold electrode 32 face each other across a micropore 30. Further, electrodes 33 are connected to feed a current to each pair of electrodes selectively. They constitute major components of a structural body. The planar gold electrode 31 and the rod-like gold electrode 32 are electrodes to generate a non-uniform electric field in a micropore 30. The electrode 33 impresses an alternating voltage on the planar gold electrode 31 and the rod-like gold electrode 32, and in this Example the electrodes 33 are connected individually with the respective planar gold electrode 31 and rod-like gold electrode 32.

Next, a procedure for producing a cell array structural body of this Example will be described with reference to the drawings. FIGS. 12 to 14 illustrate the procedure for producing a cell array structural body of this Example.

FIG. 12 is a plan view from the upper side of the substrate of the first structural element to be used for producing the cell array structural body of this Example. The element has the first glass substrate 34 with a thickness of 1.0 mm pierced by square micropores 35 with a side length of 500 μm. The micropores 35 are arranged to form a grid of 4×4 with gaps of 3.0 mm.

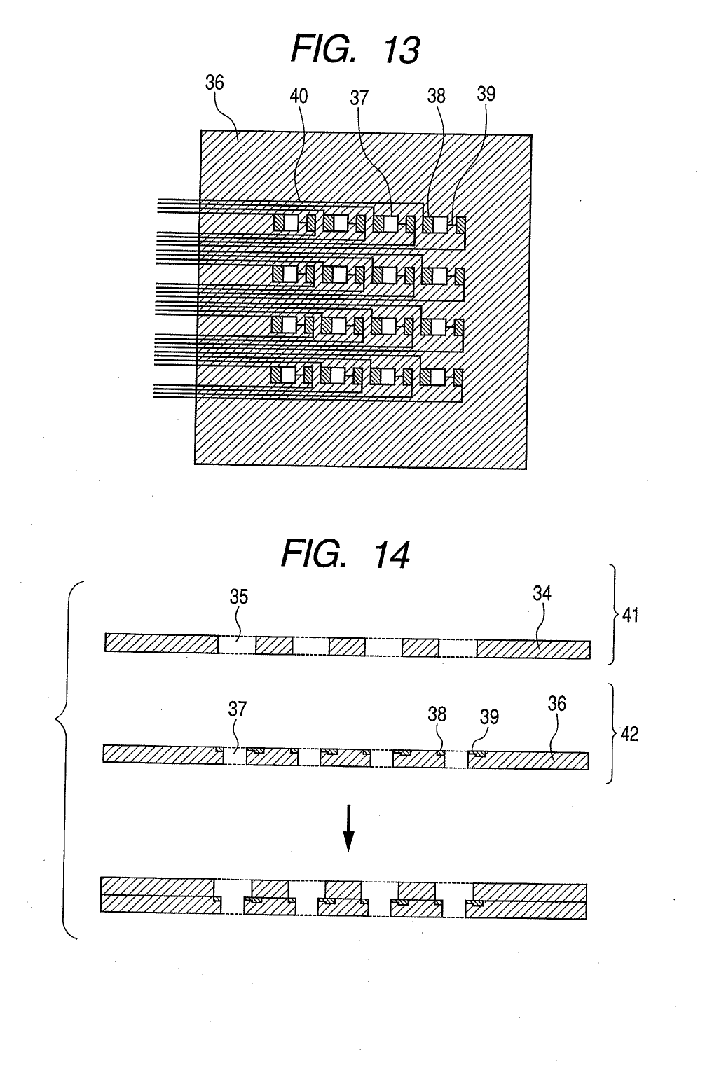

FIG. 13 is a plan view from the upper side of the substrate of the second structural element to be used for producing the cell array structural body of this Example. The element has the second glass substrate 36 with a thickness of 1.0 mm pierced by square micropores 37 with a side length of 300 μm, and a planar gold electrode 38 arranged parallel to a side of the micropore 37 and a rod-like gold electrode 39 arranged perpendicular to another side parallel to the above-described side. Namely, the gold electrode 38 has a plane on the inner wall surface of a micropore 37, and the rod-like gold electrode 39 is arranged perpendicular to this plane, which constitute a pair of electrodes for each micropore. The planar gold electrode 38 and the rod-like gold electrode 39 are connected to a power source via electrodes 40. The micropores 37 are arranged to form a grid of 4×4 at the locations corresponding to the micropores 35 of the first structural element.

FIG. 14 is a cross-sectional view of the first structural element and the second structural element illustrating a procedure for producing the cell array structural body of this Example using these elements. The first structural element is prepared by covering the first glass substrate 34 with a blast mask and piercing micropores 35 by sandblasting. The second structural element is produced by forming planar gold electrodes 38, rod-like gold electrodes 39 and electrodes 40 by vapor deposition and photolithography on the second glass substrate 36, then placing a blast mask thereon, and piercing micropores 37 by sandblasting. After arranging the micropores collinearly, the first structural element 41 and the second structural element 42 are laminated with a bonding agent to build a cell array structural body of this Example.

### Example 6

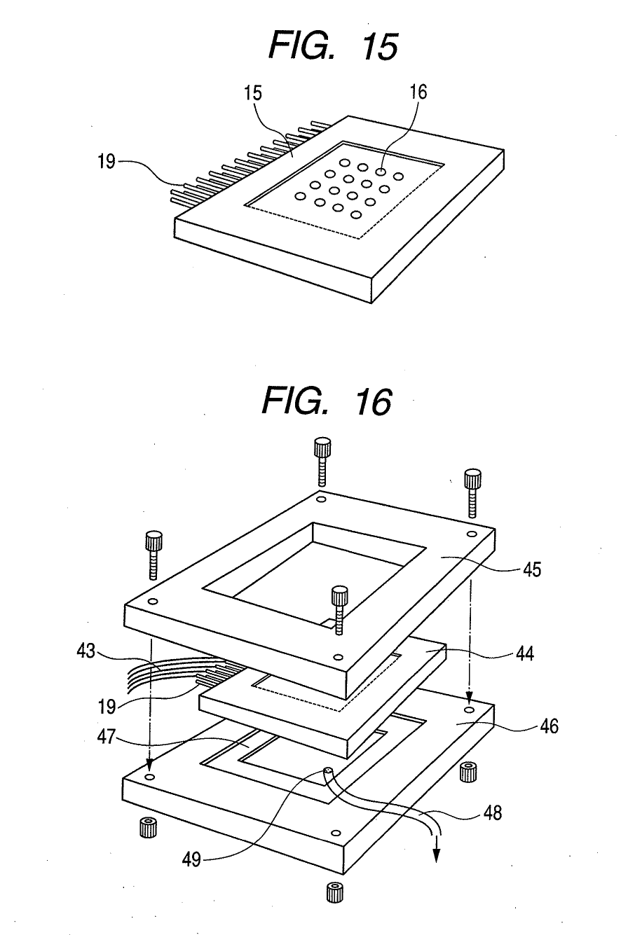

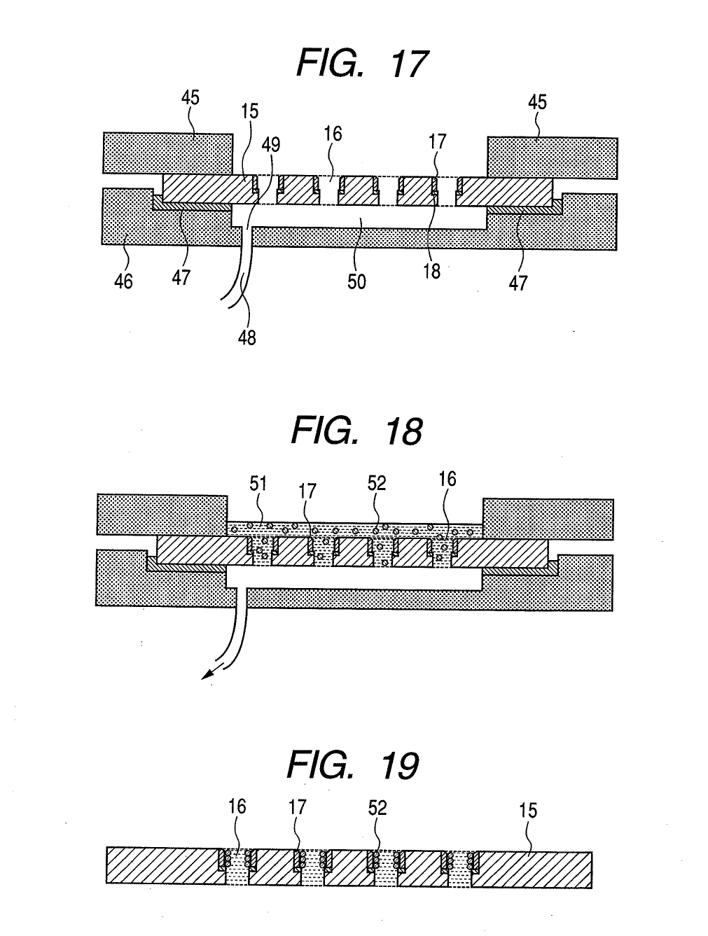

A cell array structural body according to Example 1 (FIG. 15) is mounted on substrate holders as illustrated in FIG. 16 and FIG. 17. The cell array structural body 44 is connected to a power source by electric cords 43 connected to electrodes 19 to supply power to electricity-heat converters. The cell array structural body 44 is fixed between the substrate holders 45 and 46. The substrate holder 46 is provided with a silicone gasket 47 and an outlet 49, which is connected with a suction unit such as a vacuum pump through a silicone tube 48. By reducing the pressure of a space 50 under the cell array structural body 44 through the outlet 49, a fluid, such as a cell suspension, a culture medium, a buffer solution, a reaction reagent and a sample drug solution, fed on the upper side of the cell array structural body 44 can be introduced into micropores 16. Likewise such a fluid in micropores 16 can be discharged.

To produce a cell array using a cell array structural body according to Example 1, the environmental temperature of the cell array structural body is set at 20° C., and raises the temperature inside the micropores 16 to 37° C. by feeding electricity to the electricity-heat converters. The temperature-responsive polymer layer 17 is made of poly(N-isopropylacrylamide) and equipped with an electricity-heat converter. Above the transition temperature of 32° C. it is weakly hydrophobic, and when cooled below the temperature it turns to highly hydrophilic. Consequently under the abovementioned initial conditions, the temperature-responsive polymer layer 17 on the wall surfaces inside the micropores 16 are hydrophobic and cell-adhesive. In this connection, a suitable electric current to heat a micropore 16 to 37° C. should better be determined in advance for each micropore using a temperature probe. Next a suspension liquid 51 suspending HepG2 cells (human hepatoma cell line) at 1.0×10⁷ cells/mL in a PBS (−) buffer solution (pH 7.4, 2.68 mM KCl, 1.47 mM KH₂PO₄, 136.9 mM NaCl, 8.06 mM Na₂HPO₄) is filled on the upper surface of the cell array structural body. Then by sucking gently from the lower side of the substrate holders, the suspension liquid is introduced into the micropores 16 as illustrated in FIG. 18. The introduced cells adhere to the temperature-responsive polymer layer 17 constituting a cell-adhesive surface, and are captured there. Then the cell array structural body is removed of the cell suspension liquid remaining on the upper surface, and is incubated for 30 minutes. Then a PBS (−) buffer solution is filled on the upper surface of the cell array structural body, and then sucked gently into micropores 16. By discharging the introduced buffer solution, cells not captured are removed, and captured cells are washed to complete a cell array with HepG2 cells 52 captured in the micropores 16 as illustrated in FIG. 19.

### Example 7

A cell array of this Example is produced as in Example 6 except that the cell array structural body of Example 2 is used instead of the cell array structural body of Example 1.

### Example 8

A cell array of this Example is produced as in Example 6 except that the cell array structural body of Example 3 is used instead of the cell array structural body of Example 1.

### Example 9

A cell array of this Example is produced as in Example 6 except that the cell array structural body of Example 4 is used instead of the cell array structural body of Example 1.

### Example 10

A cell array of this Example is produced as in Example 6 except that HeLa cells (human cervical cancer cell line) are used instead of HepG2 cells.

### Example 11

A cell suspension liquid containing 1.0×10² cells/mL of HepG2 cells in a PBS (−) buffer solution is prepared. A cell array of this Example is produced as in Example 6 except that the above-described cell suspension liquid is used instead of the cell suspension liquid used in Example 6. Under a microscope it should be confirmed that each micropore or the cell array retains a cell only. If more than 2 cells are captured in a micropore, the power to the electricity-heat converter of the micropore is cut to lower the temperature below 32° C. for release, and resume the power supply to raise the temperature to 37° C. for recapture. The cycle is repeated until the number of the captured cell becomes 1.

### Example 12

A cell array structural body is mounted on the substrate holders as in Example 6 except that the cell array structural body of Example 5 is used instead of the cell array structural body of Example 1. In this Example a Multifunction Synthesizer 10 (NF Corp.) different from a power source for electricity-heat converters used in Example 1 is used to impress voltage on electrodes to generate a non-uniform electric field for capture/release of sample cells.

To produce a cell array using a cell array structural body, a suspension liquid suspending 1.0×10⁷ cells/mL of HL60 cells (Human promyelocytic leukemia cell line) in 200 mM sucrose aq. solution is filled over the upper surface of the cell array structural body. Then by sucking gently from the lower side of the substrate holders, the suspension liquid is introduced into the micropores 30 as illustrated in FIG. 11. An alternating voltage (10 V, frequency 10 kHz) is impressed on electrodes built in micropores 30 to generate a non-uniform electric field in micropores 30. An HL60 cell in a micropore 30 is captured by the rod-like gold electrode 32 in FIG. 11 owing to the dielectrophoresis phenomenon. The remaining sample cell suspension liquid over the upper surface of the cell array structural body is removed. Then a washing liquid is filled over the upper surface of the cell array structural body and sucked gently, maintaining the impressed voltage on the electrodes, to introduce the washing liquid into the micropores 30. By discharging the inflowing washing liquid, cells not captured are removed, and captured cells are washed to complete a cell array of this Example with sample cells captured in micropores 30.

### Example 13

A cell array of this Example capturing E. coli is produced as in Example 12 except that Escherichia coli DH5α is used instead of HL60 cells.

### Example 14

A murine splenocyte is cultivated with a RPMI1640 medium (Nihon Pharmaceutical Co., Ltd.) and washed by filtration and centrifugation three times to recover non-adherent cells, which are used as sample cells. All other conditions are the same as Example 12 to obtain a cell array of this Example capturing the non-adherent cells. It should be examined under a microscope that a single cell is captured in a micropore of the cell array. If 2 or more cells are captured in a micropore, the electricity to the relevant electrodes is cut temporarily for release, and after washing with a buffer solution the power supply is resumed to recapture a cell. The cycle is repeated until a micropore captures a single cell only.

### Example 15

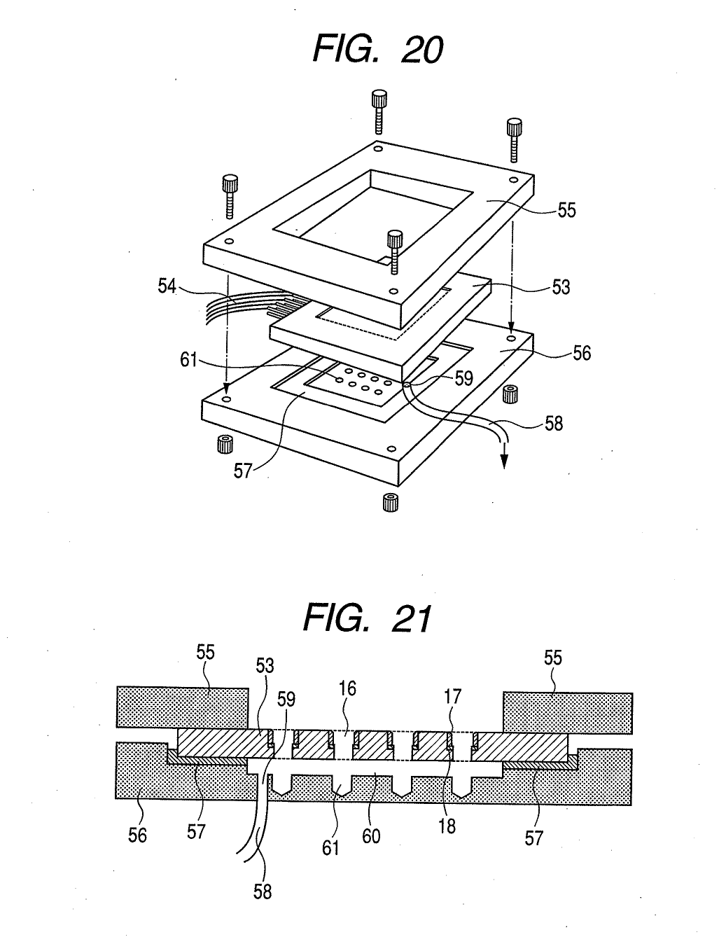

FIG. 20 and FIG. 21 illustrate an example of a construction for recovering cells or reactant solutions from the respective micropores of a cell array of Example 6 to Example 11. Any of the cell arrays of Example 6 to Example 11 is mounted to substrate holders as illustrated in FIG. 20 and FIG. 21. The cell array 53 is connected with a power source through electric cords 54 to supply a current to electricity-heat converters. The cell array 53 is fixed between the substrate holders 55 and 56. The substrate holder 56 is provided with a silicone gasket 57 and an outlet 59, which is connected with a suction unit such as a vacuum pump through a silicone tube 58. By reducing the pressure of a space 60 under the cell array 53 through the outlet 59, a fluid, such as a cell suspension, a culture medium, a buffer solution, a reaction reagent and a sample drug solution, fed on the upper side of the cell array 53 can be introduced into micropores 16. Likewise such a fluid in micropores 16 can be discharged and received in collector wells 61 located directly under the micropores 16. In order to harvest a cell in a specific micropore, the power to the electricity-heat converter of the micropore is cut off to lower the temperature below 32° C. to release the cell, and by sucking gently the desired cell can be recovered into a collector well 61.

### Example 16

Identically with Example 15, except that a cell array of Example 12 and Example 13 instead of a cell array of Example 6 to Example 11 is used, cells or reactant solutions from the respective micropores can be recovered for each micropore of the cell array.

### Example 17

A cell array of Example 14 is mounted to the substrate holders described in Example 6. An antibody solution of a labeled anti-CD4 antibody reagent (Coulter Clone T4-FITC, Beckman Coulter, Inc.) diluted 60-fold with a serum-containing PBS (−) buffer solution is filled over the upper surface of the cell array. Then by sucking gently from the lower side of the substrate holders, the solution is introduced into the micropores 30 as illustrated in FIG. 11. After removing by pipetting the antibody solution remaining over the upper surface of the cell array, the array is left reacting in dark at 25° C. for 30 minutes. Then a PBS (−) buffer solution is filled over the upper surface of the cell array structural body, and by sucking gently the buffer solution is introduced into the micropores 30. By discharging the buffer solution immediately, the captured cells are washed. Then a hemolytic agent (OptiLyse C, Beckman Coulter, Inc.) is filled over the upper surface of the cell array, and by sucking gently from the lower side of the substrate holders, the solution is introduced into the micropores 30 as illustrated in FIG. 11. After removing by pipetting the hemolytic agent remaining over the upper surface of the cell array, the array is left reacting in dark at 25° C. for 30 minutes. Then a PBS (−) buffer solution is filled over the upper surface of the cell array structural body, and by sucking gently the buffer solution is introduced into the micropores 30. After being left standing in dark at 25° C. for 15 minutes, the introduced buffer solution is discharged.

The cell array is removed from the substrate holders for examination under a fluorescence microscope (excitation wavelength 490 nm, fluorescence wavelength 520 to 540 nm) of the fluorescence from the respective micropores, to detect a cell presenting the CD4 marker. If emission of the fluorescence in 4 of the 16 cells is detected, the 4 cells are CD4 positive.

Then the cell array is mounted to the substrate holders as described in Example 15. In order to recover the cells in the micropores, in which the fluorescence has been detected, a PBS (−) buffer solution is filled over the upper surface of the cell array, and after stopping the electricity to the electrodes generating the non-uniform electrical fields in the relevant micropores, by sucking gently, the desired cells can be harvested into the collector wells.

With the above-described cell array structural body of the present invention and the cell array therewith, a liquid can flow through a micropore retaining a sample cell(s) from one opening to the other opening. Consequently, exchange of a culture medium or a drug solution, and washing of the cells are quite easy to be done. Further, selection and harvest of a specific cell is quite easy, since capture/release of a cell at a micropore can be regulated individually.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-069083, filed Mar. 16, 2007, which is hereby incorporated by reference herein in its entirety.

What is claimed is:

1. A cell array structural body comprising a substrate, a plurality of micropores piercing the substrate from one surface to another surface, through which a sample cell can pass, and a capture/release unit for the sample cell on a wall surface of each micropore.

2. The cell array structural body according to claim 1, wherein the capture/release unit for the sample cell comprises as a constituent a stimuli-responsive polymer exposed on the wall surface of the micropore.

3. The cell array structural body according to claim 2, wherein the stimuli-responsive polymer is a temperature-responsive polymer.

4. The cell array structural body according to claim 3, wherein an electricity-heat converter is equipped in the vicinity of the temperature-responsive polymer.

5. The cell array structural body according to claim 4, wherein the electricity-heat converter is equipped for each micropore.

6. The cell array structural body according to claim 1, wherein the capture/release unit for the sample cell comprises as constituents electrodes to generate a non-uniform electric field.

7. The cell array structural body according to claim 6, wherein the electrodes constitute a pair comprising a plate electrode and a rod-like electrode facing each other.

8. The cell array structural body according to claim 1, wherein a cross-section of the micropore of a region between a region with the capture/release unit for the sample cell and an opening at a surface is same or larger than a cross-section of the micropore of the region with the capture/release unit for the sample cell, and a cross-section of the micropore of at least a part of a region between the region with the capture/release unit for the sample cell and an opening at another surface is smaller than the cross-section of the micropore of the region with the capture/release unit for the sample cell.

9. A cell array which comprises: a cell array structural body comprising a substrate, a plurality of micropores piercing the substrate from one surface to another surface, through which a sample cell can pass, and a capture/release unit for the sample cell on a wall surface of each micropore; and the sample cells retained in the micropores.
